(19) United States
(12) Patent Application Publication
(10) Pub. No.: US 2012/0101416 A1
(43) Pub. Date: Apr. 26, 2012

(54) Deep Muscle Messager

(76) Inventor: Robert Kendall, Fairport, NY (US)

(21) Appl. No.: 12/886,352

(22) Filed: Oct. 25, 2010

(51) Int. Cl. A61H 15/00

(52) U.S. Cl. 601/118

(57) ABSTRACT

An apparatus for providing massaging stimulation and relaxation effects on back muscles by using the weight of the human body on a supportive structure of tennis balls that are allowed to move freely as a result of the motion of the body.

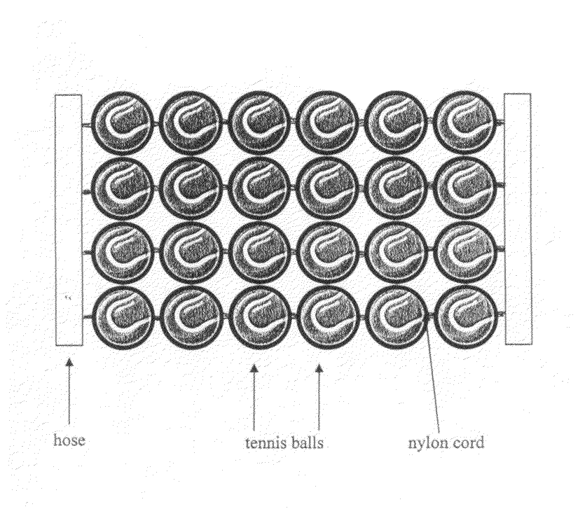

This apparatus is comprised of tennis balls, 24(although this number can be increased) in a 6 by 4 array. They are connected by nylon cord. This connection is made by drilling a hole on opposite sides of each ball and inserting the cord through the balls. One continuous cord connects six balls and is then attached to a ¾ inch rubber hose (10 inches in length) at each side of the first and sixth ball. This attachment is made by drilling a hole through the rubber hose, inserting the nylon cord through both holes and tying the nylon cord as the outside of the hose, so that the six balls touch each adjacent ball. This process is reproduced three additional times. Each time a row of six balls is connected to the rubber hose, the next row of balls touch the bottom of the previous row of balls (2¾ inches below the previous holes made through the hose). Each row of six tennis balls is attached to the hose in a similar fashion.

Usage

A person places the array of six balls of four rows on a rug. The person lies on the rug with the massager under his or her back (with the spine between the 3^{rd} and 4^{th} balls in each row), and the rubber hose aligned to the sides of the body. The person will slide slowly up and down on the massager using his or her body weight to compress the tennis balls. This compression produces the massage effect on the back. The person continues to rolling the tennis balls with the back, up and down on the balls, covering the top to bottom of the spine.

1. The deep muscle massager is unique in the use of the tennis balls, which support the back without injuring the back, and allowing enough pressure to stimulate the large and extremely small muscles in the back. Also unique is the distinctive manner of connecting the balls with the nylon cord, allowing the balls to rotate freely under the weight of the human body, producing the messaging effect. The synergy of the unique use of tennis balls combined with the manner in which the balls are connected produce a therapeutic device to relax the back muscles.
